(19) United States
(12) Patent Application Publication
(10) Pub. No.: US 2008/0181828 A1
(43) Pub. Date: Jul. 31, 2008

(54) Ultrasound one-quarter wave separator integrates with sterile tubing kit - optical sensing / valves manage purity - lowers apheresis extra corporeal blood volume - replacement for centrifuge

(76) Inventor: William P. Kluck, Renton, WA (US)

Correspondence Address: James & Kittikan Smith, 1926 W. Casino Rd Apt B201, Everett, WA, 98204, US

(21) Appl. No.: 11/657,295

(22) Filed: Jan. 25, 2007

(51) Int. Cl. B06B 1/00

(52) U.S. Cl. 422/128

(57) ABSTRACT

A one-quarter wave separation chamber of an ultrasound resonator is effective at particle/fluid/living cell separation, and can integrate with a sterile-disposable kit. Resonator is part of a continuous flow closed system, and can replace the centrifuge for blood separation into constituents. Resonator is optically monitored for cell type/volume near each exit port to control outlet valves maintaining collection purity. Uncollected cells/plasma can return to donor patient. Apheresis benefits: less extra corporeal blood volume, decreased processing time, smaller system size, lower instrument cost, reduced haemolysis, and lower cost kits. The separation chamber of the kit can be efficiently coupled acoustically to the resonator body using evacuating sealing gaskets surrounding the interface. Cooling medium can flow through resonator counteracting temperature increase tendency with higher power applications. Nonresonant secondary ultrasound can be applied to the resonator to fluidize/facilitate aggregated cell egress from exit ports.

### BACKGROUND

1. Field of invention

Embodiments of my invention apply to ultrasound particle separation. Devices of this art apply ultrasound to a resonator such that acoustic standing waves are created within. The separation chamber of the resonator is the component through which passes fluid to be separated. As fluid traverses the separation chamber, each constituent particle of the fluid is affected by ultrasound differently then are other fluid particles. As a result, similar particle types group together in layers which are harvested/collected through outlets completing the separation process.

The fluid can be a hydrosol (a liquid in which are suspended one or more different particle types) to be separated. The fluid can be a liquid in which is a solution of gas bubbles to be separated. The fluid can be a mixture of immiscible liquids to be separated.

The design of one important application for my invention will be described in detail—that being separation of whole blood into cellular components (apheresis) for the medical therapy of photopheresis.

2. Description of Prior Art

### Micro Acoustic Separators

The art of ultrasound separation of fluids into constituents can be divided into two fields of work. One field can be identified as “micro acoustic separators”. This title is appropriate as the size of the separation chambers through which the fluid enters, flows through during ultrasound exposure, and exits as separated constituents are microscopic in size. They are generally referred to by researchers/inventors as “channels” and must be viewed with a microscope.

The channels are fabricated by chemical etching substrate material (such as glass) using semiconductor manufacturing processes, methods, and equipment. These channels are typically 250 microns size in the dimension transverse to the standing wave of frequency around 1.5 MHZ.

The reason for the micro size is to be able to accommodate microbiological needs of working with tiny volumes of fluids approaching living cellular scale.

Some of these researchers/inventors of micro acoustic separators had discovered an important advantage to applying a one-half standing wave to the channel (instead of 1 wave, or 2 waves or 100 waves). That advantage being that only one ultrasound node exists within the channel (the node being a layer location where one constituent particle type gathered). By occupying only one node, these separated particles were more easily harvested (by an even smaller—about ⅓ the size of the channel) exit “canal” located at the node layer.

Researcher N. R. Harris et. al., in A Silicon Microfluidic Ultrasonic Separator from Sensors and Actuators B95, 2003, pp. 425-434 describes a representative example of a one-half wave micro acoustic separator. The resonator was designed so that the node occurs in the center of the channel. As with all inventors/researchers of micro acoustic separators, little was described about how collection purity is maintained. The frequency used to create this one-half wave (in water) was 3 MHz. The article diagrams show collection ports of a size about 250 microns. It would certainly be difficult or impossible to control particle flow out of these ports with valves (valves of this size just doesn't exist). Valves could not be seen with the human eye and would have to be seen with a scanning electron microscope.

A few researchers/inventors applied a one-quarter wave to the channel instead of the more typical one-half wave. They observed that the node within the channel with this design was located at a channel wall (instead of at the channel center with the one-half wave design above). It can be understood that these micro acoustic separators would not be very useful for separating large amounts of fluids/particulates because the microscopic channel flows would yield only drops of harvested product in any reasonable time period and are also prone to clogging. Apheresis (blood separation into constituent cells/plasma) for example dictates practical size volumes of 50 ml and up to around a liter to be separated in only minutes.

All prior invention (micro and macro) acoustic separators are prone to contamination of one particle with another for reasons to be later discussed. It is advantageous to add optics and purity control valves to the separator to prevent this contamination. However, it is most difficult if not impossible to optically monitor particulate type and concentration near a collection canal and actuate valves to control contamination when these optic elements or valves would have to physically be of a size around 50 microns.

There would be great advantages to scaling up a micro acoustic separator (one-quarter wave device—one node), to a practical separation size for applications other than microbiological. There would be enormous advantages to adding collection purity control valves and monitoring optics to the large scale separation channel/chamber to render particulate collection free from contamination.

### Macro Acoustic Separators—General

The second art field of work can be identified as “macro acoustic separators”. This title defines the size of the separation chamber through which the fluid enters, flows through while exposed to ultrasound, and exits as separated constituents. These separators are large in size (certainly visible by eye, exceeding 5 ml in size and typically exceeding about 30 ml).

Researchers/inventors in this field have never designed macro acoustic separation chambers with a one-quarter standing wave, but instead have designed chambers which typically included hundreds of standing waves. They realized that it was not practical to have a collection outlet at each of the hundreds of nodes. They have somewhat overcome the problem of collecting the same particle constituent from hundreds of node layers present in their separation chamber by many ingenious methods.

### Method—Traveling Standing Wave—Macro Acoustic Separators

Several inventors have presented different design concepts to collect the hundreds of node particle layers by altering the strict standing wave. They made the standing wave “migrate/travel/propagate” in the direction of its axis. As this traveling wave migrates toward a separation chamber wall, it carries with it all the hundreds of node particulate collections. When each of these particulate collections comes into contact with the wall, they deposit along the wall (creating a new large particulate layer). Collection occurs from an outlet located near this wall.

U.S. Pat. No. 3,826,740 by Warren, Jul. 30, 1974 presented a design which created the traveling wave by including two acoustic transducers on either side of the separation chamber (along a common axis) that were of slightly different frequencies so that a low frequency traveling “beat wave” was created. This beat wave migrated the many layers toward the wall.

Another traveling wave invention, U.S. Pat. No. 4,759,775 by Peterson et. al., Jul. 26, 1988 shows a design which created a traveling wave by having a transducer on only one side of the separation chamber, and an acoustic mirror on the opposite side. The mirror was made to move in a direction of the wave axis. As the incident transducer waves reflected off the moving mirror, they acquired a slightly different frequency (because of Doppler effect) and introduced a low frequency traveling “beat wave” within the separation chamber. This beat wave migrated the many layers toward the wall.

The traveling wave separation in both of these examples, and all similar traveling wave patents unfortunately all include the same deficiency. Even though these traveling wave ultrasound separation patents have succeeded in combining collection layers from hundreds to one, the one layer harvesting is problematic. As one attempts to collect the single particle layer from a wall, other particle types have also gathered at the same wall (as they are also swept to the wall by the traveling wave), and have contaminated the harvest. A multi-particulate harvest cannot be very pure using traveling wave assisted collection!

Method—Gravity Settling Of Layers/Standing Wave is Shut Off—Macro Acoustic Separators Gravity applies an attractive force on each individual particle within a fluid. Gravity attempts to settle out the particle on the bottom of the separation chamber.

Additionally, each individual particle within a fluid is exposed to microscopic level collisions from other kinetically (Brownian) moving molecules and particle types within the fluid. Brownian collisions tend to bounce the particle around with no particular directional preference.

Finally, a frictional force acts upon a particle with the surrounding fluid (Stokes theories). These forces attempt to keep the particle from moving around (confined to a position as if a pea were stuck in a thick syrup).

The strength of collision forces and fluid frictional forces often overpower gravitational forces acting upon a particle. As a result, many types of particles may remain in fluid suspension for hours or longer and not be able to settle out of the fluid by gravitational force. The smaller that the particle is, the more likely that it will not settle out.

Particulate separated by ultrasound into layers usually aggregate or flocculate together into clumps or masses within these layers. These clumps are affected by Brownian and frictional forces differently than are constituent individual particles. Because of their large size (aggregation of thousands of attracted particles), they are not easily bounced around by tiny Brownian particle collisions. Because of their large mass, gravity settling force can overcome frictional forces with the fluid. As a result, aggregated clumps of a separated particulate can settle out of a fluid, even if individual constituent particles of the same would remain in suspension.

Several inventors presented designs, which have somewhat, overcome the problems of collection from hundreds of separated layers by using gravity settling. One inventor U.S. Pat. No. 4,055,491 by Asher, Jun. 2, 1976 presented a design, which created standing waves within a separation chamber. Separated particulate grouped together in hundreds of thin layers (hundreds of nodes) within the separation chamber. Layered particulate aggregated into clumps. The invention simply turned off the ultrasound generator (halting the separation process) after the layers and clumps formed. During this “quiet” period of time, gravity forces overcame fluid frictional forces and Brownian collision forces. Gravity settled out clumps (independent from which horizontal layers they came from) to the bottom of the separation chamber. The new thick composite bottom layer was then harvested through an outlet port at the bottom of the separation chamber.

Maintaining purity of collected particulate from this invention is difficult. As clumps of a sought after particulate settle on the bottom, other ultrasound particle layers containing unwanted particulate also settle out on the bottom, and so the sediment is contaminated. If one were interested in only separating for example water from all other particles, then this invention would work well. But if one tried to perform apheresis (whole blood separation), and collect only red cells, this invention would not work. The bottom layer would contain and harvest not only red cells, but also white cells, platelets, etc. In general this invention cannot be used to separate multiple particulates from a fluid. Additionally, the gravity settling time is too lengthy for typical separation applications.

### Method—Second Traveling Wave at a Bias to Primary Standing Wave—Macro Acoustic Separators

Several inventors have made collection easier from the hundreds of nodes/layers present within their separation chambers by introducing a second traveling wave perpendicular (or at a bias) to the separation traveling wave.

U.S. Pat. No. 4,475,921 by Barmatz, Oct. 9, 1984 in [FIG. 7] presented a design that created a standing wave in a separation chamber (along a primary axis). Again hundreds of separated particle layers formed perpendicular to the axis. This invention applied a second traveling wave perpendicular to the axis of the first. The second wave sweeps the hundreds of separated layers toward a wall of the separation chamber thus combined them into a large single layer.

But, this invention is again problematic. Realize that if the separation chamber is oriented so that the primary axis is vertical, the separation layers form horizontally. The perpendicular traveling wave also moves horizontally and deposits a vertical layer on the vertical outlet wall. It can be understood that while one force (separation acoustics) attempts to layer horizontally, it is interfered with by another force (traveling wave) attempting to layer vertically. The result of this interaction necessarily mixes up particle types. Again, the harvest cannot be very pure using dual traveling wave assisted collection.

### Theory of Ultrasound Particle Separation—(Foreword)

To aid understanding of the principles of my invention, theory of ultrasound particle separation should be understood. For theory and discussions going foreword, the word “particle” separation shall mean not just separation of solids suspended in a hydrosol, but immiscible liquids separation, and undissolved gas within a liquid separation.

Most researchers in the field of ultrasound separation have stated that the reason why particles tend to gather at either ultrasound standing wave nodes or at antinodes were not understood.

Experimental Observations By Inventors in the Art of Ultrasound Separation:

If a chamber contains, as an example, particles suspended in water, and if the chamber is resonated with ultrasound so a standing wave is created within, researchers have observed:
i. The fluid within the standing wave separation chamber does not experience constant acoustic energy throughout its volume. Instead the chamber includes (for flat acoustic generators of this discussion) planes of very low acoustic energy called nodes and planes of very high acoustic energy called antinodes. Experiments show that the quantities of these node/antinode planes vary with the portion of standing wave contained within the chamber. Specifically for each one-quarter standing wave there will exist one node and one antinode. If a resonating chamber hosts many full standing waves, there will exist many planes of nodes and many planes of antinodes all equally spaced apart.
ii. Each of the constituents of a fluid has its own set of particular acoustic properties. For example, yeast cells in suspension with water contains two constituents (water molecules and yeast cells). Sets of acoustic properties are complex in that they are influenced by particle size, particle shape, particle compressibility, particle density, etc. But for understanding of separation device design, it is only necessary to understand very well that acoustic energy interacts with each constituent differently from the others.
iii. A fluid inhibits motion of any constituent molecule or particle moving through it depending on particle relative frictional properties. These frictional properties are again unique for each molecule or particle within a fluid. The inhibiting motion (or friction) for each molecule or particle is again complex (however better understood than node aggregation) (reference “Stokes settling equations”) and depends on size, shape, temperature, and others. For understanding of separation device design, it is only necessary to understand that each molecule or particle experiences a friction or resistance to its motion through a fluid that is different from the other particles.

### Current Theory of the Art to Explain Above Observations

Researchers/inventors in the art of ultrasound separation devised a theory to explain the observations above: This theory is stated: some particles migrate to an acoustic node and other particles migrate to an acoustic antinode for reasons not understood. This theory tries to explain observations similar to the example above, where water would be observed at antinodes and yeast cells near nodes. For the case where a separation chamber contains two nodes and three antinodes, there can be observed one band of water at each of the three antinodes and one band of yeast cells at each of the two the nodes.

Author Filip Petersson et al., in Separation of lipids [fats] from blood utilizing ultrasonic standing waves in microfluidic channels, Dept of Electrical Measurements, Lund Institute of Technology, Lund, Sweden, Aug. 18, 2004 has even “refined” this theory to the extent where he assigned numeric values and directional signs to particles (pertaining to whether they gather at a nodes or antinodes and how strongly). For example, he assigns red blood cells as value as +0.3 and lipid (fat) particles as −0.3.

### Theory of Ultrasound Particle Separation—New Theory

True are the observations of i.-iii. above, however the current theory explaining “what causes this behavior” is not understood or stated correctly. As such it is not too useful for ultrasound separation device design. A new and more useful theory is:

All particles tend to gather at nodes (none have attraction for antinodes), but it is impossible for all particles types to be at the same place, so particles with the strongest acoustic properties “win” node locations and displace particles with weaker acoustic properties—eventually the particles with the weakest acoustic properties “lose” to occupy antinode locations.

Applying this new theory to the yeast example above results with the yeast particles gathering near the planes of the nodes and displacing water molecules away from these nodes (toward the antinodes).

Another example could further help new theory understanding. Envision a fluid within a one-quarter wave separation chamber containing water, red blood cells, and white blood cells. Observations of ultrasound separation indicate that the particle with the strongest acoustic properties (red cells) will gather in a layer at the node. That along side of the red cell layer will gather a white cell layer (of relatively weaker acoustic properties)(also trying their best to reach the node). Finally outside of the white cell layer, will be observed water molecules (having the weakest acoustic properties)(also trying their best to reach the node). Water having the weakest acoustic properties is forced furtherest from the node (at antinode position).

Since there must be a continuum of particles in the chamber (near the exit ports), particle layers space out in proportions to their constituent volume ratio.

To further understand the volume ratio effect consider another example containing lipid (fats) particles (volume 15%), and red blood cells (volume 25%), within water (volume 60%). Under a one-quarter wave ultrasound exposure, red cells will aggregate in a layer at the node zone displacing both lipids and water. Displaced within a layer adjacent to the red cell layer will be water. The water layer will displace lipids. Lipids (particles of lowest acoustic properties) will form a third layer outside of the water layer (which happens to be at the antinode zone).

In the last example, the one-quarter wave chamber contains only one node alongside one chamber wall and one antinode alongside the opposite chamber wall. Arbitrarily assume the chamber size (perpendicular to the wave axis) is 1.00 inch, then the node wall near the exit ports will build up a layer of red cells 0.25 inch thick (because 25% volume). The central portion of the chamber near the exit ports will build up a water layer extending from 0.25 inch to 0.85 inch thick (because 60% volume). The upper chamber wall (antinode side) near the exit ports will have a thickness of lipid particles extending from 0.85 inch to the wall (1.00 inch) (because 15% volume).

Note none of the constituents (not water, nor red cells, nor lipids) are attracted toward the antinode, but none-the-less, lipids are observed in a layer at the antinode wall.

Even more importantly, realize that if one were to quickly deplete red cells at the node bottom wall (by pumping them away quickly), that for some short time period water would advance to the node wall (as there are few local red cells at this instant in time to displace them), and separation would fail as water would exit the red cell port. Red cell harvest contamination would continue until enough additional fluid was pumped into the chamber, through to the exit end, and until new separated red cells replenish their node layer near their exit port at the bottom wall.

### Why?—The Reason for the New Theory

The reason why all molecules (gas and liquid) and particles (solids) move to standing wave node planes and try to escape antinode planes (when possible) is not difficult to explain. Understanding results from applying the 2^{nd} law of thermodynamics (entropy law).

This law can be stated: when energy is applied to matter causing it to gain kinetic energy and achieve a higher state of disorder, that nature tries to find a way to lower the state of disorder and reduce kinetic energy within the matter.

Applying this law to ultrasound separation of suspended particles within a standing wave (containing node planes of low acoustic energy and antinode planes of high acoustic energy) results with a new theory to the art of ultrasound separation:

All particles when subjected to acoustic energy at antinode planes reach a higher state of disorder, and by the laws of nature attempt to move away toward lower entropy/lower kinetic energy states existing near node planes.

The corollary is also true: Particles avoid (if possible) moving toward antinode planes (as they will achieve higher states of disorder and kinetic energy), but instead try to escape antinodes by moving toward nodes.

With this new theory understood, it can become clear why prior art ultrasound separators have realized less commercial success then was possible and have experienced less than desirable collection particle purities. For example, with all the ultrasound inventions patented on apheresis, today a preponderance of the medical industry still separates blood into constituents using centrifuges! Prior inventors with old theory understanding have designed ultrasound inventions in where they have faithfully positioned collection exit ports at location of ultrasound nodes and have expected that only the strongest acoustic properties particles would exit there from. But, often, unexpected particles exited at the node port location and comprised collection purity. “Reason—they have not realized heretofore that the weaker acoustic property particles are waiting their turn displaced just outside the nodes to also rush in and occupy the node locations after depleted stronger acoustic property particles exit the chamber. They did not realize that once the stronger acoustic property particles were harvested in proximity of node exit ports, that the separator would be for some time harvesting weaker acoustic property particles. When this instant in the process occurs, the separator collection particle purity is comprised. This comprise would continue until the separator fills with new mixture solution, and until weaker acoustic property particles became displaced away from the node exit port by replenished stronger acoustic property particles.

In other words, with prior art ultrasound separators, there was no guarantee that only the desired particulate would exit its designated port. All published micro acoustic separator inventions (even if they were one-quarter wave channels) would under commonly occurring conditions eventually harvest undesired constituents at a particular collection port!

Contamination was particularly common if the liquid/particulate volume ratios were other than 50%/50%. No prior inventors described pure (or near pure) micro acoustic separators practical to separate solutions that were much different than 50%/50% by volume, or which were not of constant volume mixture by time.

Contamination from prior inventions can be understood by presenting an example: If a hydrosol contained 80% water and 20% plant cells by volume, the plant cells would be acoustically forced to the node wall of the channel (one-quarter wave separator) and as such displace water to the opposite antinode wall of the channel. The node exit port would begin well enough by collecting plant cells. The antinode exit port would collect water. If the relative egress/collection rates of the two ports were about equal (i.e. the exit ports are about equal in diameter as they were portrayed in prior inventions), there would come a time when most of the plant cells near the exit port were depleted and so would not be able to displace water from the node side of the channel. When this happened, local water would flow to the node port, and the node port would begin harvesting water (or water mixed with a lesser volume of plant cells).

A not too practical solution for this collection purity problem (for imbalance of constituent volume ratio relative to the exit port sizes) is to attempt to measure the precise mixture volume ratio and then size the exit ports to exactly match flow rates to this ratio. However this solution is not effective for hydrosols whose volume ratios vary ever so slightly with time. Additionally, for micro acoustic separators, it is not so practical to adjust exit flow rates (port sizes) when the exit port is of microscopic size/diameter about 0.010″ (as would be the case if a particle occupied only 1% of hydrosol volume).

A more practical solution for this problem is my invention where in the micro acoustic separator is enlarged to a size where conventional valves can be placed in conveyance with each exit port. Thus when an outlet port has near depleted local particles for which it is to collect, its corresponding valve could be restricted in flow until the proper particle population near its particular outlet returns to a harvestable magnitude. Using this solution, an operator of the device could visually watch for constituent depletion and trigger valve closure when appropriate.

Carrying this solution one step further, an embodiment of my invention adds to the macro acoustic separator—optical sensor devices near each exit port. These sensor devices connect to electronics circuitry and in turn to the corresponding valves. In this manner, a constituent near an outlet is automatically monitored for near depletion and automatically restricts corresponding valve flow until replenishment occurs. Note application of both valves and optical sensors of my invention would not be practical if the separation device were micro acoustic in size as described by prior inventors using one-quarter standing wave separators.

No researchers/inventors of micro acoustic separators have described attempts to enlarge channels to a size (over 100 times larger) for practical separation of industrial sized volumes of fluids/particulates, or allowed for adaptation of valves/optical sensors to compensate for variable volume mixture rates.

Furthermore no researchers/inventors of macro acoustic separators have designed one-quarter wave separation chambers, allowing for simpler/purer harvesting methods.

### SUMMARY OF MY INVENTION

### General

My invention discloses a standing wave ultrasound particle separator that includes a unique separation chamber. The separation chamber of my invention is the first in the art to contain only one (one-quarter wavelength) standing wave, and at the same time is physically large enough (over about 5 milliliters—not microscopic size) to accommodate a broad spectrum of separation applications. Its collection purity is an order of magnitude better!

### Integrating Valves

The separation chamber of an embodiment of my invention integrates valves at its outlets to allow control of collection purity. Valve purity control is necessary when the fluid constituent volume concentration changes over time or has a constituent with a low volume percentage concentration.

### Integrating Optics/Controller with Control Valves

An embodiment of my invention is the first in the art to add optical emitter/sensor pairs near separation chamber outlets. These optic pairs sense particle type and concentrations present near each outlet. This knowledge is conveyed to a programmed electronics controller that can manipulate outlet valve flows maintaining collection purity.

### Integration with a Kit

An embodiment of my invention is the first in the art to integrate its separation chamber with a kit. This kit contains and confines the entire fluid flow system, and can be easily insertable and acoustically attached to the resonator of my invention. Utilizing the kit integration design of my invention embodiment can provide an inexpensive, one-piece disposable, and sterile system for applications to broader separation procedures such as those used in medical, and large-scale biological fields.

### Integrating Coupling—Compliant Bias Force

An embodiment of my invention is the first in the art to use a compliant bias force (such as an air bag) to acoustically couple the separation chamber to the resonator transducers providing simple and fast interconnection.

### Integrating Coupling—Seals/Vacuum

An embodiment of my invention is the first in the art to use vacuum evacuated sealing gaskets to acoustically couple the separation chamber to the resonator transducers providing even faster interconnection.

### Integrating Resonator Cooling

An embodiment of my invention attaches inlet and outlet cooling ports, and flow path to the resonator facilitating coolant flow offsetting any tendency of the device to warm up during high power ultrasound applications.

### Integrating Aggregate Fluidizing

An embodiment of my invention integrates an additional non-resonant ultrasound generator to assist (fluidize) aggregated (grouped/flocculated) particle egress from outlet ports.

### Summary of Embodiments Objectives

The embodiments of my invention include specific operational improvements over prior art inventions:

One object of my invention provides for more economical particle harvesting (one-quarter wave) because its separation layers are the maximum thickness possible. The thicker the separation layer, the easier it is to collect and pump particle types from the separation chamber. The larger can be the exit ports and tubing for example.

Another object of an embodiment of my invention is to improve collection/harvest particulate purity. Improved purity is accomplished by fabricating the one-quarter wave separation chamber large enough in physical size so that exit valves can be added to each outlet. These valves adjust each outlet flow depending on particulate type and concentration present near the outlet.

Still another embodiment of my invention connects these valves to outlet optical sensing devices in conveyance with an electronics controller. With such design, an invention object is to automatically adjust outlet flows depending on particulate type and concentration near an outlet.

Another object of an embodiment of my invention is to make ultrasound particle separators useful for medical and biological applications requiring sterility and preferring disposable kit integration.

Other and further objects of my invention will be apparent from the following description when read in conjunction with the accompanying drawings.

By way of example, my invention is illustrated herein by the accompanying drawings, wherein:

### DRAWING FIGURES

FIG. 1 is a perspective view of a transducer subassembly used in the resonator of my invention shown before adhesive bonding.

FIG. 2 is a perspective view of a transducer subassembly used in the resonator of my invention shown after adhesive bonding.

FIG. 3 is a perspective view of my invention in its most basic embodiment.

FIG. 4 is an acoustic diagram of the ultrasound standing wave present within the resonator of my invention.

FIG. 5 is an exploded perspective view of my invention resonator including the embodiment of cooling and the embodiment of acoustic coupling by vacuum/sealing gasket.

FIG. 6 shows exit valve alternative embodiment of my invention.

FIG. 7 shows exit valve with optic sensors and electronic controller alternative embodiment of my invention.

FIG. 8 shows dislodging (fluidizing) non-resonant acoustic alternative embodiment of my invention.

FIG. 9 shows my invention separation chamber integrated with an example of a disposable sterile kit—system used for apheresis/photopheresis.

Names and Numbers used in Drawing Fig.'s and Specification

| F1 | bond force f1 |
|---|---|
| F2 | bond force f2 |
| M2 | coupling force m2 |
| M1 | coupling force m1 |
| 12 | groove upper |
| 13 | groove lower |
| 14 | piezo top |
| 15 | piezo bottom |
| 16 | electrode bottom |
| 17 | electrode center |
| 18 | electrode top |
| 19 | clamp layer |
| 20 | wire top |
| 21 | wire center |
| 22 | wire bottom |
| 23 | transducer upper |
| 24 | separation chamber |
| 25 | transducer lower |
| 26 | invention |
| 26a | invention (embodiment with valves) |
| 26b | invention (embodiment with valves, optics, and |
| | electronic controller) |
| 26c | invention (embodiment with dislodging |
| | acoustics) |
| 27 | inlet tube |
| 27a | inlet |
| 28 | valve center |
| 29 | outlet tube upper |
| 29a | outlet upper |
| 30 | outlet tube center |
| 30a | outlet center |
| 31 | outlet tube lower |
| 31a | outlet lower |
| 32 | valve lower |
| 33 | valve upper |
| 34 | switching circuit |
| 35 | non-resonant energy source |
| 36 | ultrasound energy source |
| 37 | bottom wall |
| 38 | top |
| 39 | bottom |
| 40 | emitter block |
| 40a | closed position |
| 41 | sensor block |
| 42 | emitter I |
| 43 | sensor I |
| 44 | arrow sensor |
| 45 | arrow emitter |
| 46 | electronic controller |
| 47 | cable valve center |
| 48 | cable valve upper |
| 49 | cable valve lower |
| 50 | cable emitter |
| 51 | cable switching circuit |
| 52 | cable sensors |
| 53 | nodes on axis |
| 54 | antinodes |
| 55 | cooling inlet |
| 56 | vacuum inlet upper |
| 57 | upper gasket seal |
| 58 | lower gasket seal |
| 59 | vacuum inlet lower |
| 60 | cooling outlet |
| 61 | resonator |
| 65 | saline bag |
| 66 | return pinch clamp |
| 68 | filter |
| 69 | pressure dome return |
| 70 | collection pinch clamp |
| 71 | anticoagulant bag |
| 72 | pump AC |
| 73 | collection pump |
| 74 | pressure dome collection |
| 75 | air detector and trap |
| 76 | return pump |
| 77 | waste pinch valve |
| 78 | waste bag |
| 79 | saline pinch valve |
| 80 | saline bag |
| 81 | drip chamber |
| 82 | four-way connector a |
| 83 | four-way connector b |
| 85 | return pinch valve |
| 86 | treatment bag |
| 87 | collection pinch valve |
| 88 | treatment pump |
| 89 | uv light |
| 90 | treatment cell |
| 91 | treatment pinch valve |
| 92 | emitter II |
| 93 | emitter III |
| 94 | emitter IV |
| 95 | emitter V |
| 96 | sensor II |
| 97 | sensor III |
| 98 | sensor IV |
| 99 | sensor V |

### DESCRIPTION OF THE PREFERRED EMBODIMENTS

### Assembly Transducer Basic

Major components of invention 26 are transducers. FIG. 1 shows the components and assembly of one of these transducers. The top 38 includes a groove upper 12 machined around the periphery (about 0.05 inch deep and 0.05 inch wide). The bottom 39 has another similar groove lower 13. These grooves are used for adhesive binding as will be later presented. An alternating sandwich of three thin electrodes (electrode top 18, electrode bottom 16, and electrode center 17) with two piezoelectric plates (piezo top 14 and piezo bottom 15) are stacked at the center of the transducer. Note each of the electrodes has a tab protrusion for electrical connection. A quantity of two thin piezoelectric plates is chosen to keep the excitation voltage low while providing sufficient ultrasound separation power. Piezoelectric plate volume determines the resonator 61 power while piezoelectric plate thickness determines the voltage needed. For piezoelectric plates preferably about 0.007 inch thick, voltages can be kept non-hazardous around 20 volts. Alternately, one or three (or more) piezoelectric plates can be used for lesser or higher power transducers.

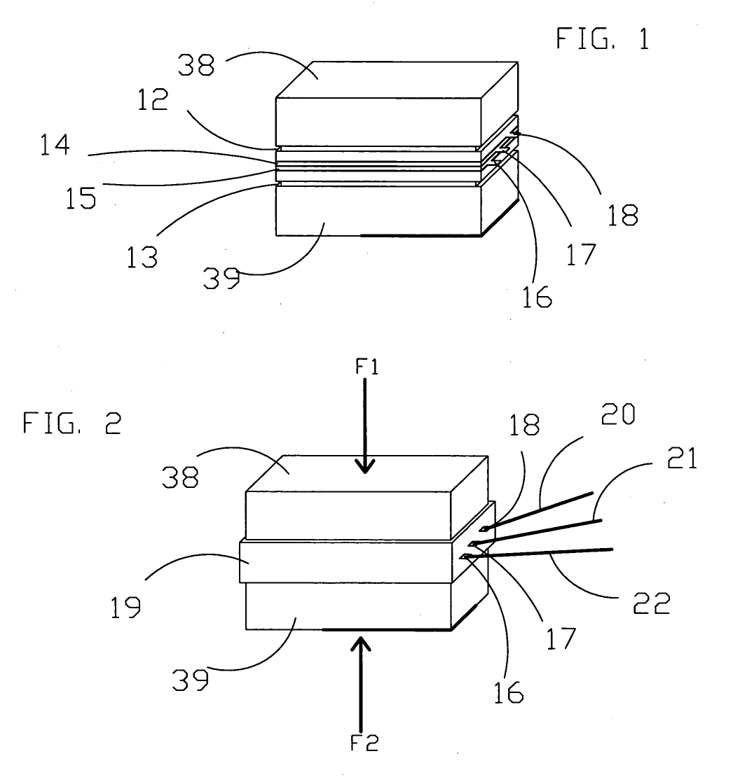

Next assembly step of a transducer presses the stack together as shown in FIG. 2 by bond force F1 and bond force F2 while the stack is placed in an adhesive mold (not shown). The mold includes a hollow channel around the stack into which is poured epoxy adhesive. When the epoxy has cured, the bond force F1 and bond force F2 are removed; and the stack is removed from the mold. A new epoxy clamp layer 19 was formed extending into groove upper 12 and groove lower 13. The clamp layer 19 holds the transducer together, acts as an electrical insulator, seals the stack from humidity, and applies a preload force in the direction of bond force F1. The wall thickness of the clamp layer 19 should be about 0.04 inch. The preload is caused by the inherent characteristic of epoxy to shrink in size in the range of 1-3 percent while curing. The preload force keeps piezo top 14 and piezo bottom 15 under compression during dynamic electrical excitation. Maintaining compression is necessary for piezo materials as they can destruct under relatively low-tension forces.

To complete the transducer assembly, three wires (wire top 20, wire center 21, and wire bottom 22) are welded to the three connection tabs of electrode top 18, electrode bottom 16, and electrode center 17.

The thickness of the transducer stack particularly the top 38 and bottom 39 components are critical for proper resonator 61 operation.

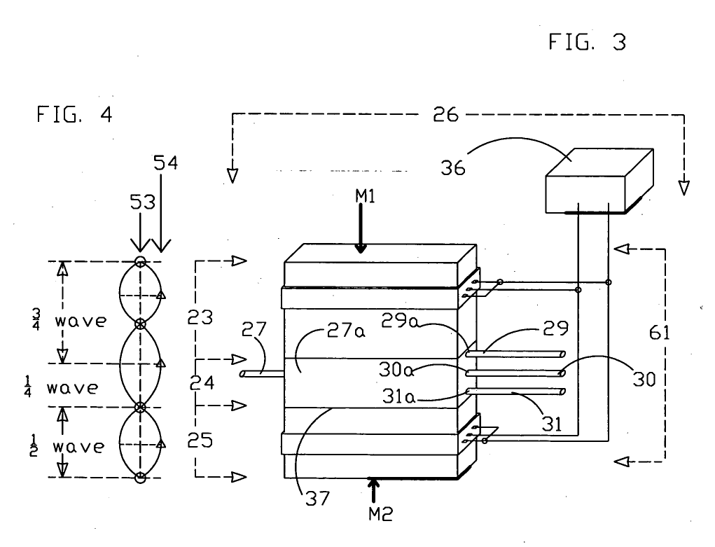

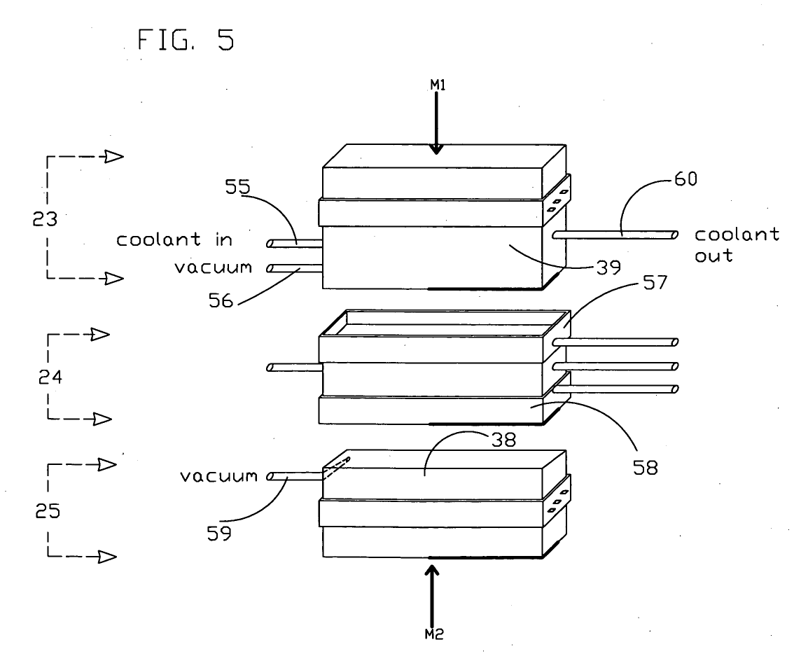

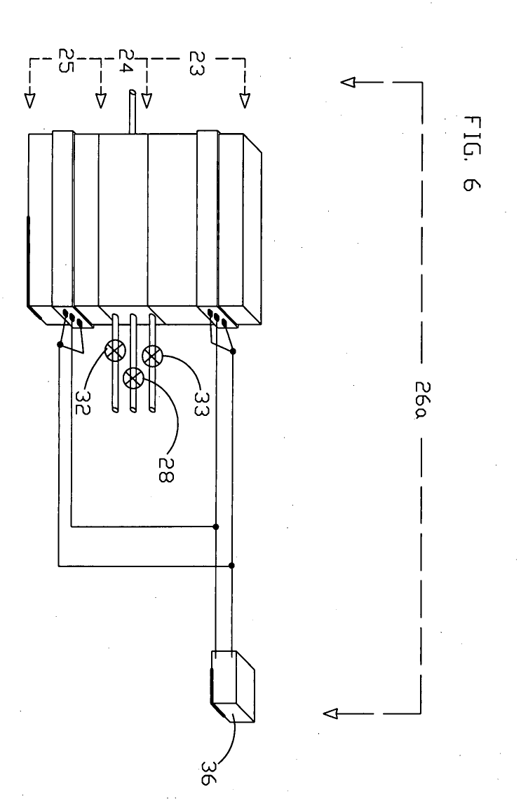

Referring to FIG. 4, there is shown the desired standing wave form for resonator 61 shown alongside FIG. 3. Note the resonator 61 standing wave includes three nodes on axis 53, and three antinodes 54. Notice the transducer upper 23 has a thickness of ¾ wave, the transducer lower 25 has a thickness of ½ wave, and the separation chamber 24 has a thickness of ¼ wave. The transducer lower 25 must have its top 38 and bottom 39 of equal thickness so the antinode 54 occurs exactly at the center of the piezo stack. The transducer upper 23 is a little different in that its bottom 39 must be twice the thickness of its top 38 so an antinode 54 occurs exactly at the center of the piezo stack. Overall, the resonator 61 has a thickness of 1½ standing waves. The purpose of all this proportionate thickness matching is in the end is so that the separation chamber 24 during resonance is exactly one-quarter wave thick as is shown in FIGS. 3, 4.

Converting the identified standing wave proportions to physical dimensions depends upon the desired frequency of operation and material from which components are made. Selection of materials for top 38 and bottom 39 components depends upon the acoustic impedance of the fluid solution used within the separation chamber 24. For optimum resonator 61 performance, it is desired to choose as close as is possible a match between the acoustic impedance of the top 38 and bottom 39 materials with the acoustic impedance of the fluid solution. When this impedance matching is close, there will be minimum wasteful reflected acoustic waves coming from the liquid/component interfaces. For example, for apheresis, plasma liquid is about 92% water so the acoustic impedance will be near 1.48×10 exp6 kg/m exp2 sec. A closely matching material to this acoustic impedance is polyethylene with value 1.76×10 exp6 kg/m exp2 sec.

Care is taken so the operating resonant frequency chosen results with the physical size resonator 61 desired. For apheresis, a frequency about 20 KHz will provide a useful size separation chamber 24 and also limit damaging cavitation. Since the material and frequency are known, physical resonator 61 dimensions can be calculated:

The standing wave length for a material is found with the equation: wavelength=v (acoustic velocity of material)/frequency. For polyethylene, v=1.95×10 exp3 m/sec, so wavelength in the polyethylene resonator 61 will be 0.098 meters or 3.84 inch. Therefore the proportioned physical dimensions for components of the resonator 61 (frequency 20 KHZ) will be:

| | | |
|---|---|---|
| top 38 of transducer lower 25 | ¼ wave | 0.96 inch |
| bottom 39 of transducer lower 25 | ¼ wave | 0.96 inch |
| top 38 of transducer upper 23 | ¼ wave | 0.96 inch |
| bottom 39 of transducer upper 23 | ½ wave | 1.92 inch |
| separation chamber 24 | ¼ wave | 0.96 inch |

The overall height of the resonator 61 will be nearly the sum of all these major components or 5.76 inches. The minimal thickness of the piezoelectric plates and electrodes (each around 0.005 inch) relative to other component calculated sizes are not significant and also not important in that the ultrasound energy source 36 shown in FIG. 3 will be selected to be variable and it will be easy to find the exact system resonance frequency by fine tuning.

The electrodes (electrode top 18, electrode bottom 16, and electrode center 17) can be made from laser cut copper shim stock of thickness 0.003 inches. The piezoelectric plates (piezo top 14 and piezo bottom 15) can be made from laser cut or diamond wheel sawed PZT SA material model T105-A4E-602 PZT made by Piezo Systems Inc, 186 Massachusetts Ave, Cambridge, Mass. 02139.

FIG. 3 shows three components of invention 26 (transducer upper 23, transducer lower 25 and separation chamber 24). In order for ultrasound energy to be able to flow properly through these three components and create the standing wave shown in FIG. 4, there must exist “acoustic coupling” amongst them. Permanent bonding of the three components must be excluded if the separation chamber 24 is to be easily removable from the rest of invention 26 and can also be part of a disposable tubing kit. One method to acquire the acoustic coupling is to apply compliant forces in the axial direction of the standing wave. FIG. 3 shows coupling force M1 and coupling force M2. These forces M1 and M2 can result from any number of devices universally used and well understood by those working in this art such as air bags or piston/air cylinders (not shown).

### Transducer Feature for My Invention Embodiment—Vacuum Coupling

Referring to FIG. 5, there is shown transducer upper 23 embodiment including a vacuum inlet upper 56 in conveyance with the under side surface of its bottom 39. Similarly there is shown transducer lower 25 embodiment also with a vacuum inlet lower 59 in conveyance with the upper surface of its top 38. This embodiment of the transducers with application of a vacuum to vacuum inlet lower 59 and vacuum inlet upper 56 will cause pressure sealing of the transducers (23, 25) with separation chamber 24 and provide necessary acoustic coupling amongst the three components. More details on the vacuum acoustic coupling embodiment of invention 26 will be presented when describing the separation chamber 24.

### Transducer Feature for My Invention Embodiment—Cooling

Also shown in FIG. 5 is transducer upper 23 embodiment including cooling inlet 55 and cooling outlet 60 tubes. These tubes are in conveyance with each other so coolant flowing into cooling inlet 55 will flow through bottom 39 and exit cooling outlet 60. In doing so, the bottom 39, and separation chamber 24 coupled thereto can be cooled offsetting any tendency of invention 26 to warm up during high power ultrasound energy separation.

### Separation Chamber 24 Basic Design

FIG. 3 shows a basic embodiment of separation chamber 24 component of invention 26. Separation chamber 24 can be designed as simple as a hollow box with an inlet tube 27 on one end and multiple outlet tubes on the opposite end. Separation chamber 24 is shown with three such outlet tubes (outlet tube center 30, outlet tube upper 29, and outlet tube lower 31). Included at the start of outlet tubes (29, 30, and 31) are openings (outlets 29a, 30a, and 31a) in the separation chamber 24 corresponding with tube positions though which liquids can egress. Similarly, at the end of inlet tube 27 is an opening inlet 27a in the separation chamber 24 corresponding to its tube position through which can enter the fluid.

The material selected for the separation chamber 24 should be optically clear to be adaptable for optical sensing of its contents. In addition, the material should be compatible for sterile blood flow when used for apheresis/medical type applications. The material should also be semi-rigid because if the vacuum sealing gasket option is designed into the separation chamber 24, the gasket will need to be compliant to tightly enclose a vacuum seal. One material that meets these requirements is semi rigid clear PVC.

Fabrication of the separation chamber 24 can be accomplished by roto-molding melted PVC resin in a mold. A second method for separation chamber 24 fabrication is injection molding of two halves and solvent bonding the halves together. With either fabrication method, the completed separation chamber 24 can be sterile, include reinforced ports for bonding attachment of inlet and outlet tubing, have any wall thickness desired, and be economical enough in price to be disposable. When the separation chamber 24 is attached to other tubing and components of a separation kit, the entire kit can be economical enough to be one-use and disposable.

### Separation Chamber 24 for My Invention Embodiment—Vacuum Coupling

FIG. 5 shows an embodiment of the separation chamber 24 feature added for My Invention Embodiment—Vacuum Coupling. A vacuum is used to provide acoustic coupling between the transducer upper 23, transducer lower 25, and separation chamber 24. With the design of this embodiment of separation chamber 24 shown, both the top and bottom faces of separation chamber 24 have added an integral semi-flexible sealing upper gasket seal 57 and lower gasket seal 58. The seals (57, 58) can be added to the separation chamber 24 by simply adding female grooves in the mold used to fabricate the separation chamber 24.

After the separation chamber 24 is positioned between the transducer upper 23 and transducer lower 25, a vacuum is applied to vacuum inlets (59, 56). Vacuum sealing will cause the three components to be tightly and acoustically coupled, yet allow for easy removal of the separation chamber 24 when the separation procedure is completed, and the vacuum is removed. The magnitude of the vacuum generated coupling force can be calculated from the product of vacuum magnitude and the separation chamber 24 surface area. As an example, if the vacuum selected causes a differential pressure of 11 psi and the size of the separation chamber 24 face was 1 inch×5.76 inch, the coupling force would be (11×5.76) or 63 pounds. This range of 63 pounds proves to be an excellent preload operating range for piezoelectric elements of invention 26.

### Basic Embodiment Invention 26

FIG. 3 shows a basic embodiment of invention 26. Shown are transducer upper 23, transducer lower 25, and separation chamber 24 acoustically coupled by coupling forces M1 and M2. The transducer electrode tabs (shown better in FIGS. 1 and 2) are shown welded to lead wires (wire top 20, wire center 21, and wire bottom 22). The lead wires are electrically connected to an ultrasound energy source 36. The ultrasound energy source 36 should be selected to have a variable output frequency matched to the transducers (25, 23) and separation chamber 24 resonate frequency (20 KHz is a reasonable value). In addition the ultrasound energy source 36 operates well with a sign wave output waveform of variable power to 50 watts and with voltage variable to 20 volts. Many manufacturers supply such a product including Agilent Technologies of Santa Clara, Calif. 94306, model 332550A.

Invention 26 has established within the resonant structure a standing wave 1½ waves high. Of particular significance is that within the separation chamber 24 is established a one-quarter wave. In general, operation has liquid aggregate entering the separation chamber 24 through inlet tube 27, separating into constituents by the ultrasound one-quarter standing wave, and pure constituents exit the separation chamber 24 through outlet tubes (29, 31, and 30).

### Details—Particle Separation by Invention 26

Separation specifics of a hydrosol within the separation chamber 24 design above can best be described by an example: Assume the hydrosol contains water, lipids, and red blood cells; each 33% by volume. Ultrasound energy will begin energizing the hydrosol immediately upon its entry through inlet tube 27. As shown in FIG. 4, the top of the separation chamber 24 contains the standing wave antinode and the bottom of the separation chamber 24 contains the node at bottom wall 37. All constituents of the hydrosol will be forced away from the antinode (top) and will attempt to move toward the node plane (bottom wall 37). However, not all constituents can move to the bottom wall 37 at the same time. The separation chamber 24 has to remain full, so only the particles with the greatest acoustic properties (red cells) will begin layering at the bottom wall 37. The fluid with the second strongest acoustic properties (water) will begin layering over the red cells. The fluid with the weakest acoustic properties (lipids) will begin layering over the water. As the mixture is pumped from inlet tube 27 to outlet tubes across the separation chamber 24, the separation layering will become more and more pronounced (purer). By the time several seconds go by [location near the outlet tubes (29, 30, 31)], the layers become pure constituents! The bottom ⅓ layer will be all red cells, the top ⅓ layer will be all lipids, and the central ⅓ layer will be all water. The outlet upper 29a, outlet center 30a and the outlet lower 31a in this basic design are placed to maintain purity of the exiting constituents. As such, the outlet center 30a is at the center of the separation chamber 24 and thus harvests the water constituent. Similarly the outlet upper 29a is at the very top of the separation chamber 24 and harvests lipids. Finally, the outlet lower 31a is at the very bottom of the separation chamber 24 near bottom wall 37 and harvests red cells.

The advantage of my invention design having the separation chamber 24 with only one node (one-quarter wave) can best be understood by examining a different separation chamber 24 thick enough (one-half wave) to include two nodes and one antinode—(so the antinode is in the center). In this more problematic design, the red cells would now gather at two node locations in two layers at the top of separation chamber 24 and at the bottom of separation chamber 24. Water would be forced away by the red cells and gather in a layer along side each of the red cell layers (two total layers). Finally lipids would group at the center layer (antinode) being forced furthest way from both nodes by both red cells and water. As if harvesting from this configuration isn't complex enough, the constituent layer thicknesses present further problems for harvesting.
i. Each of the outer two red cell layers would (one-half wave design) would be only ⅙ the thickness of the separation chamber 24 height
ii. Each of the next inward two water layers would also be ⅙ the thickness of the separation chamber 24 height
iii. The centermost lipid layer would be ⅓ the thickness of the separation chamber 24 height (no collection problem here)

It is easy to imagine the added harvesting complexities (and possibilities for contamination) that would be introduced by trying to use this one-half wave thick separation chamber 24 instead of this invention 26 design having one-quarter wave thick separation chamber 24.

With the one-half wave thick separation chamber 24, there would be five harvest outlet tubes for the three constituents instead of three outlet tubes of invention 26. Important also is that four of the five layers become one-half the thickness of layers of invention 26. With outlets increasing from three to five, and layers becoming one-half as thick, it becomes much more likely to have mixing (contamination) of the constituents at the outlet tubes.

### Invention 26a—Embodiment Adding Valves

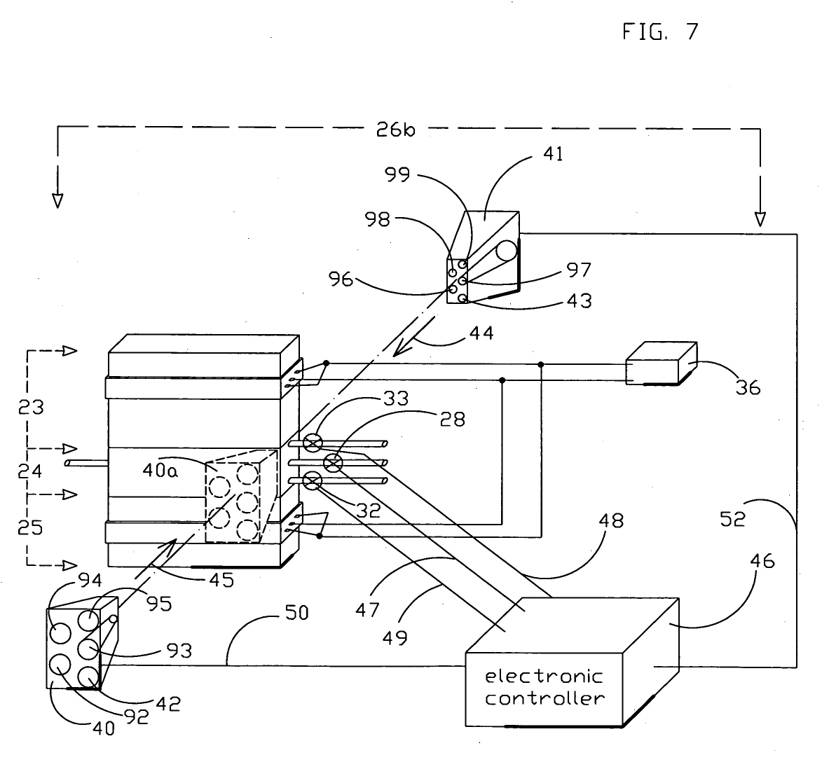

FIG. 3 viewed along with FIG. 6 shows a valve upper 33 added to the outlet tube upper 29, another valve center 28 added to the outlet tube center 30, and a third valve lower 32 added to the outlet tube lower 31. Preferably these valves are electrically operated and of a type that can pinch off flow through flexible exit tubing (much like a pliers can do to a garden water hose). By using this type of valve, kit (including the separation chamber 24) tubing can be inserted into the valves without including the valves as part of the kit. Operator of invention 26a can watch a particular constituent accumulation near an outlet, and allow collection flow only when build up (local layer thickness) near the outlet is great enough to prevent accidental contamination from adjacent particle layer build ups.

This embodiment—invention 26a becomes essential if the incoming hydrosol volume mix ratio varies with time. For example, if the volume ratio of a hydrosol is ⅓, ⅓, and ⅓ and the exit outlets are positioned at the top, center and bottom of separation chamber 24; then harvest of the three components would be reasonable and contamination less likely. However, consider for example, the constituent with the greatest acoustical properties (strong enough to gather at the bottom wall 37) reduces to only 1% volume. Then outlet lower 31a would tend to contaminate quickly (without having valve lower 32) and harvest not only the particulate intended, but also the particulate with the second strongest acoustic properties. This happens as the lower layer (near bottom wall 37) is normally only 1% of the separation chamber 24 thickness (and is thinner than the diameter of the outlet lower 31a). The outlet lower 31a area would then overlap two layers (bottom layer and next inner layer)—thus allowing egress of two particulates at the same time. But with invention 26a embodiment, the operator could stop egress from outlet lower 31a (1% particles) by closing its valve lower 32 while harvest of other particulates continue through valve upper 33 and valve center 28. At a time when the 1% particulate builds up approaching 33% height of the separation chamber 24 (near outlet lower 31a), and totally covers outlet lower 31a area (and its harvest was assured pure), the operator could then open valve lower 32 and harvest this constituent without contamination.

### Invention 26b —Embodiment Adding Valves and Optics with Electronic Controller

Invention 26 can include an embodiment (invention 26b) where there are valves similar to those described in invention 26a, but with an addition of optics and electrical controller. The purposes of the added features are to automatically, instantaneously, and without error monitor each constituent build up near its intended outlet, and to control exit valves so harvest constituents remain pure (uncontaminated). Invention 26b embodiment is practical in that hydrosol volume mix ratios can vary with time, include mix ratios where one or more of the constituents are by volume only a fraction of a percent.

To realize this invention 26b embodiment, there can be added any multitude of light emitters/sensors placed alongside the separation chamber 24. One design option shown in FIG. 7 has five light emitters (42, 92, 94, 95, 93) illuminate through the separation chamber 24 and the hydrosol close to the outlet end of separation chamber 24. Shown also are five corresponding sensors (99, 97, 98, 96, 43) positioned to receive light transmitted through the separation chamber 24 and hydrosol horizontal layers. For this invention 26b embodiment to work, each constituent layer of a specific hydrosol must absorb transmitted light from its specific light emitters differently than does adjacent constituent layers. As such, light sensors opposite respective light emitters know if the constituent near a specific outlet is pure or contains a contaminated mixture of constituents.

Sensing information about outlet constituent purity gathered near a specific outlet can be channeled to an electronic controller 46 which can control respective outlet valve flow to assure pure harvesting of the constituent.

The five emitters within emitter block 40 are typically over 0.25 inches in diameter, and the five sensors within sensor block 41 are typically over 0.50 inches in diameter. However in order for there to be about five of each within a small confined area, the light path for both emitters and sensors at the separation chamber 24 sides of emitter and sensor blocks have to be confined to be about 0.12 inches in size. FIG. 7 drawing of sensor block 41 shows the separation chamber 24 side with small light path openings. The drawing also shows large size light path (about 0.50″ size) on the opposite side of the emitter block 40. Note emitter I 42 and sensor III 97 drawing shows a tapered hole light path configuration making the size transition possible. If the blocks were manufactured from an opaque material such as black delrin plastic, there would be no light cross illumination from one light path to another. All large sized emitters and sensors could be positioned within their blocks, and sealed in place with optically clear resin. In this manner, economical emitter block 40 and sensor blocks 41 can be made which will transmit and receive the five light paths without interference from each other and be close enough together on the separation chamber 24 sides to contain all within the confined area.

As understood, both emitters and sensors will all be in close proximity (near the outlet end of the separation chamber 24). Realize many hydrosols can refract light from all emitters simultaneously and illuminate all sensors simultaneously. To avoid confusion from which emitter activated which sensor and which constituent is being monitored, the emitter/sensor pairs are electrically multiplexed (sequenced). With this method allowing only one emitter and its corresponding sensor to be on at any one instant in time, hydrosol refraction and emitter spillover signals to sensors not intended near constituents not of concern is managed! Electronic controller 46 includes such multiplexing circuitry.

Specifics of light emitter types and frequencies, sensor models, and electronics circuits need not be detailed in this description of invention 26b as several similar systems are known to those in the art of apheresis. As an example, U.S. Pat. No. 6,419,822 by Muller, et al., Jul. 16, 2002 is a very useful reference for optics and electrical controller/circuitry used in invention 26b. Muller uses multiple light emitters and sensors to identify whole blood constituents (specifically red cells, white cells and plasma) present near its centrifuge separation device exit tubes. Muller describes red cells as having a unique red color well sensed by a pair of red LED emitters of frequency 650 nm and photodiode sensors. Muller describes white cells as having a unique milky white color well sensed by a pair of green LED emitters of frequency 571 nm and photodiode sensors. Muller describes plasma as having a unique yellowish straw color well sensed by a pairs of red LED emitters of frequency 650 nm and photodiode sensors. Muller patent [FIG. 19] shows a diagram for multiplexer, amplifiers, converters, filters, and detectors that can be used as the electrical controller 46 for invention 26b.

Blocks 41 and 40 are shown in the FIG. 7 drawing retracted from the separation chamber 24. Both blocks are designed slideable in direction of arrow sensor 44 and arrow emitter 45 until blocks just touch separation chamber 24 during separation. Emitter block 40 is additionally shown using dashed lines at closed position 40a. After the separation procedure is completed, both blocks retract to positions shown so the removable separation chamber 24 can be easily detached.

FIG. 7 shows all electronic circuitry housed in a box referred to as the electronic controller 46. The electronic controller 46 is interconnected to emitter block 40 with emitter cable 50, to sensor block 41 with cable sensors 52, to valves (32, 28, 33) with cable valve lower 49, cable valve center 47, and cable valve upper 48 respectively.

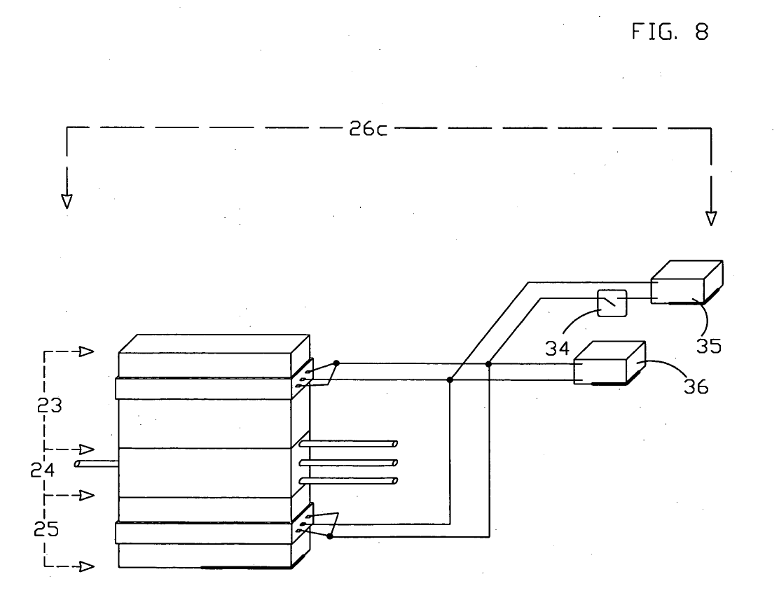

Referring to FIGS. 8 and 7, invention 26b operation will be described for the medical apheresis application. Whole blood is pumped into inlet tube 27 (flow rate about 30 ml/min) and through separation chamber 24. As blood traverses the separation chamber 24, it is subjected to ultrasound energy of one-quarter wave. Red cells having the greatest acoustic properties will begin layering on the bottom wall 37. By the time red cells reach outlet lower 31a, they will have formed a layer about 42% the thickness of the separation chamber 24 (blood volume composition of red cells). This red cell layer forces the next higher acoustic property constituent (white cells) into an adjacent layer about 1% the thickness of the separation chamber 24 (blood volume composition of white cells). Plasma fluid has the weakest acoustic properties, and will be forced over the white cell layer in a top layer about 57% the thickness of the separation chamber 24 (blood volume composition of plasma).

Initially, the lower three emitter/sensor pairs (emitter I 42/sensor I 43, emitter II 92/sensor II 96, and emitter III 93/sensor III 97) detect exclusive presence of red cells near outlet lower 31a; and trigger opening of valve lower 32. Pure red cells harvest through outlet tube lower 31. Initially, the upper three emitter/sensor pairs (emitter V 95/sensor V 99, emitter IV 94/sensor IV 98, and emitter III 93/sensor III 97) detect exclusive presence of plasma near outlet upper 29a; and trigger opening valve upper 33. Pure plasma is harvested through outlet tube upper 29.

Initially, the center three emitter/sensor pairs (emitter II 92/sensor II 96, emitter III 93/sensor III 97, and emitter IV 94/sensor IV 98) detect very few white cells; and detect mostly over-layering plasma and red cells. Therefore, the valve center 28 is kept closed, and initially no harvesting of white cells occurs.

As time passes, considerable plasma is harvested, considerable red cells are harvested, and more and more whole blood has been pumped into the separation chamber 24. White cells have not yet been harvested, and so the initial thin 1% white cell layer builds up thicker and thicker until it reached around a 33% thickness of the separation chamber 24. At this local concentration at the outlet end, the center three emitter/sensor pairs mentioned above detect exclusive presence of white cells near outlet center 30a; and trigger opening of valve center 28. Pure white cells finally begin harvest through outlet tube center 30.

Reverse sense/valve control operation also occurs. For an example if white cells had been harvesting, and the white cell center layer is thinning to the point where either red cells evade emitter II 92/sensor II 96 pair or plasma evades emitter IV 94/sensor IV 98 pair, electronic controller 46 prepares for change. The programmed electronic controller 46 goes into a state of readiness to close valve center 28 at the first introduction of either red cells or plasma at emitter III 93/sensor III 97 pair. When this does happen, valve center 28 closes before contamination can occur.

As described, integration of emitter/sensor pairs and electronic controller 46 turn on/off valves (33, 28, and 32) so that harvesting of red cells through outlet tube lower 31 remains pure, so harvesting of white cells through valve center 28 remains pure, and harvesting of plasma through valve upper 33 remains pure.

### Invention 26c—Embodiment Adding Dislodging Acoustic Energy

Many particles that separate into layers using ultrasound energy tend to aggregate or flocculate together into clusters (experiencing low energy particle bonding). These clusters do not always egress easily through outlets into tubing, especially for particles aggregated into layers along the separation chamber 24 lower and upper walls.

Invention 26c embodiment solves cluster egress hesitancy by applying non-resonant acoustic vibration to the separation chamber 24 fluidizing/breaking up clusters thus aiding exit flow. It is relatively easy to add this feature to invention 26 as the same piezoelectric plates used to drive the standing wave are used to drive the non-resonant acoustics.

FIG. 8 shows added a non-resonant energy source 35 wired in parallel with the ultrasound energy source 36. A switching circuit 34 is wired in series with the non-resonant energy source 35 to control when dislodging acoustics are applied. For apheresis, it is desirable to apply the non-resonant energy source 35 only when red cells are being harvested, i.e. when the valve lower 32 is on; and then only for one second bursts of time. A frequency that works well for red cell dislodging for the non-resonant energy source 35 is about 13 KHz. The model and manufacturer for this non-resonant energy source 35 can be the same Agilent generator as used for the ultrasound energy source 36.

### Invention 26a—System Application for Photopheresis Treatment

In overview, photopheresis is a blood therapy for treating diseases including T-cell lymphoma, autoimmune diseases, reducing organ transplant rejection, reducing grafting rejection, and various other diseases. Photopheresis procedure involves removing a quantity of whole blood from the patient and mixing it with saline and anticoagulant. The blood mixture is next separated into three primary constituents: plasma, red cells, and white cells. In prior inventions, a centrifuge was used as the separation device. In photopheresis, the separated white cells (buffy coat) are treated with the drug 8-methoxyposoralen then exposed to UV-A light. The procedure is completed with the treated white cells, red cells, and plasma being returned to the patient.

U.S. Pat. No. 6,793,643, by Briggs, Sep. 21, 2004 describes use of a centrifuge to separate whole blood into components returned to the patient and white cells (buffy coat) treated with drug 8-methoxyposoralen and activated with UV light before being returned to the patient.

In photopheresis application, invention 26a or 26b (with valves) will be used in place of the centrifuge used in invention U.S. Pat. No. 6,793,643 and all other prior photopheresis inventions.

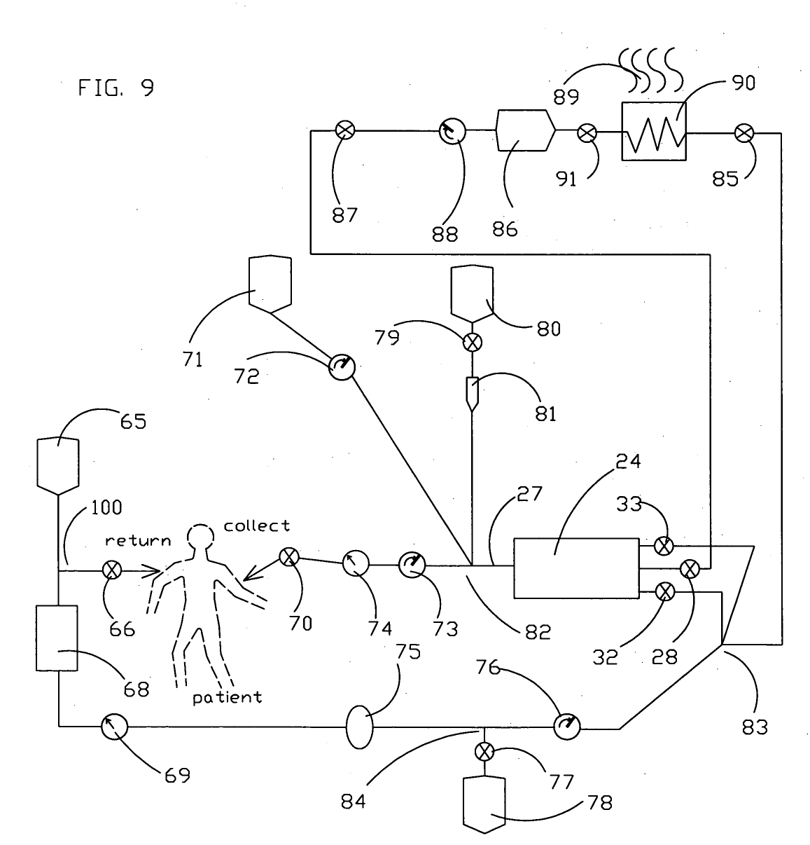

Referring to FIG. 9, there is shown invention 26a without the transducer upper 23, transducer lower 25, and ultrasound energy source 36 (all of which are shown in FIG. 3). These components are excluded from FIG. 9, as they were already described in some detail and inclusion here again would unduly complicate photopheresis application description. It has been mentioned prior that the separation chamber 24 can be part of a one-use disposable kit. This photopheresis application will describe a typical use of such a kit as are commonly used in the medical treatment field.

The kit can be comprised of PVC tubing and other plastic connected components and is disposable. In the case of pinch valves shown in FIG. 9—(87, 91, 85, 79, 77, 28, 33, 32) and peristaltic pumps (88, 73, 72, 76), kit tubing is inserted into pinch valve or into peristaltic pump to complete the system. Pinch valves and peristaltic pumps are not components of the kit, but are external to the kit and are temporarily attached to kit tubing at locations shown during treatment.

Probably, the kit and system use can best be understood/explained by first describing generic blood flow through the photopheresis system including kit and invention 26a components.

A needle within a patient (“collect” side) is connected to the beginning of the kit. Blood is pumped by collection pump 73 from the patient through collection pinch clamp 70 and pressure dome collection 74 to a four-way connector a 82. The collection pinch clamp 70 seals off the kit while connection to the patient. Pressure dome collection 74 senses patient collection pressure, and can shut down the procedure if collection pressures are either too high or too low. Whole blood is pumped through inlet tube 27 and through the separation chamber 24. As blood traverses the separation chamber 24, it is acted upon by the one-quarter wave and begins layering into constituents. Within the separation chamber 24, whole blood separates into plasma (which exits valve upper 33), white cells (which exit valve center 28) and red cells (which exit valve lower 32). For photopheresis, red cells and plasma are not used for treatment, and so are returned to the patient through four-way connector b 83 by return pump 76. On their journey to patient return, an air detector and trap 75 removes any air bubbles that might have been included. Pressure dome return 69 senses return fluid pressure, and can shut down the procedure if pressures are too high. Filter 68 removes any coagulant or impurities in the fluid just before it returns to the patient (at “return”). The return pinch clamp 66 seals off the kit while connecting to the patient.

For photopheresis, white blood cells are harvested through valve center 28 and are pumped by treatment pump 88 through collection pinch valve 87 into treatment bag 86 where they are stored until enough white cells accumulate for treatment. While in the treatment bag 86, white cell volume is injected with the drug 8-methoxyposoralen through an injection site in the treatment bag 86. When enough treated white cells accumulate, treatment pinch valve 91 opens and white cells are pumped into the treatment cell 90. Treatment cell 90 is an optically clear plastic chamber with an internal winding flow path. While white cells are held in treatment cell 90, UV light 89 radiates the treated white cells and activates the drug 8-methoxyposoralen contained within white cells. When white cells have completed treatment and activation, they too are returned through return pinch valve 85 to four-way connector b 83 and through the same flow path and components as the plasma used when returning to the patient.

Even though the principle blood flow and separation and treatment flow and mechanics have been defined, a couple of ancillary flows will complete the photopheresis system operation.

The kit components before start of therapy all contain air and so a priming flow is first required. During priming, saline from saline bag 80 flows through saline pinch valve 79 and a drip chamber 81 (used to visually monitor flow) and through four-way connector a 82 into separation chamber 24. At the same time, anticoagulant from anticoagulant bag 71 is pumped by pump AC 72 into separation chamber 24. From the separation chamber 24, the saline/anticoagulant mixture makes the same flow journey described above for both plasma and white cells, and in doing so displaces all the air trapped in kit components. The used saline/anticoagulant mixture and air travels through waste pinch valve 77 and collects in waste bag 78 for later disposal.

A third flow of anticoagulant is pumped by pump AC 72 from the anticoagulant bag 71 into whole blood flow as it enters the separation chamber 24. The anticoagulant is needed to thin the blood from a hemotocrit of about 42% to about 32% so blood coagulation does not occur during photopheresis treatment.

A forth flow of saline from saline bag 65 can be routed into the patient if extra corporeal blood collection ever exceeds about 500 ml (depending upon patient weight, sex and age).

Thus described is invention embodiment 26b used in an apheresis/photopheresis application. The separation chamber 24 is also a component of a disposable, sterile, single-use kit. Discussed prior and shown in FIG. 9 are valves (28, 32, 33) managing purity of collection (effective even when white cells contain only 1% of whole blood volume). Note, following treatment, the separation chamber 24 and the rest of the kit is removed from the other equipment identified at the treatment site and can be disposed of.

Advantages to be realized by replacing the centrifuge separator used in current inventions with this invention 26a for photopheresis include:
less extra corporeal blood volume
decreased treatment time
smaller system size
lower instrument cost
reduced haemolysis
lower cost kits
   The embodiments and descriptions above have been by way of illustration, rather than limitation. The scope and content of my invention “ultrasound one-quarter wave separator integrates with sterile tubing kit—optical sensing/valves manage purity—lowers apheresis extra corporeal blood volume—replacement for centrifuge.”being determined by the following claims:

I claim:

1. A resonator device for separating one or more particle types suspended within a fluid, integrating a separation chamber generally bounded by a thin wall so said separation chamber surrounds a volume exceeding about 5 milliliters, ultrasound energy means arranged to establish a standing wave in said resonator device so a one quarter standing wave is established within said separation chamber
a fluid inlet and a fluid outlet means for introducing said fluid, so said fluid inlet and said fluid outlet means are disposed relative to said standing wave such that said fluid flows through said standing wave transversely to axis thereof,
two or more openings comprises said fluid outlet means spaced apart in the direction of said axis so that said particle type with one set of acoustic properties is delivered to one said opening and other said particle type/s with other set/s of acoustic properties are delivered to other said opening/s whereby said particle type separation is maximum thickness, easier to collect, proceeds at higher flow rates and with higher purity.

2. Device according to claim 1, including a valving means in downstream conveyance with said openings facilitating control of said particle type egress rate out said openings whereby purer particle type collection can be performed.

3. Device according to claim 1, including a cooling fluid inlet and cooling fluid outlet means facilitating circulation of a coolant through said resonator device whereby possible heating effects caused by said ultrasound energy means can be counteracted so as to prevent said separation chamber temperature from rising.

4. Device according to claim 1, including an acoustic generating means in addition to said ultrasound energy means which operates at a non harmonic frequency to said standing wave whereby when applied to said resonator device will dislodge said particle type aggregated near said thin wall and facilitate egress through said opening/s.

5. Device according to claim 1, including a valving means in downstream conveyance with said openings facilitating control of said particle type egress rate out said openings and including optical devices near said openings operating with an electronic controller means whereby control of flow rates through respective said valving means corresponds to amounts of said particle type present near respective said openings so purer particle type collections can be performed.

6. Device according to claim 1, so said separation chamber is also an integrally connected component of a closed path sterile tubing kit whereby said separation chamber can be easily attached to remainder of said resonator device, and sterility can be easily assured for separation procedures.

7. Device according to claim 1, where said separation chamber is acoustically coupled to remainder of said resonator device with a sealing gasket means surrounding remainder of said resonator device and said separation chamber interfaces, and where interior of said sealing gasket is in conveyance with a vacuum evacuator whereby effective and quick acoustic coupling is assured to said separation chamber.
